(19) United States
(12) Patent Application Publication
(10) Pub. No.: US 2026/0329228 A1
(43) Pub. Date: Oct. 22, 2026

(54) IMAGE FORMING APPARATUS

(71) Applicant: CANON KABUSHIKI KAISHA, Tokyo (JP)

(72) Inventors: KEITA NAKAJIMA, Shizuoka (JP); YUJI MITSUI, Shizuoka (JP)

(21) Appl. No.: 19/558,901

(22) Filed: Mar. 6, 2026

(30) Foreign Application Priority Data
Mar. 17, 2025 (JP) 2025-042693

(51) Int. Cl. G03G 21/20; G03G 15/00; G03G 15/23; G03G 21/16

(52) U.S. Cl. CPC G03G 21/206; G03G 15/234; G03G 15/6552; G03G 15/6573; G03G 21/1619; G03G 21/1638; G03G 2215/00679

(57) ABSTRACT

Disclosed is an image forming apparatus including a housing including a stacking portion and an upstream wall, a transfer portion, a fixing device accommodated in the housing, a discharge member configured to discharge the sheet to which the toner image is fixed by the fixing device from an inside to an outside of the housing in the sheet discharge direction, a reversing member configured to perform a reverse conveyance of the sheet having passed through the transfer portion and the fixing device, a first conveyance guide disposed so as to separate a first conveyance path and a second conveyance path, a fan configured to generate an air flow, a first air path forming portion including a first opening formed in the first conveyance guide, and a second air path forming portion including a second opening formed in the upstream wall.

### BACKGROUND

### Field of the Technology

The present disclosure relates to an image forming apparatus that forms an image on a sheet.

### Description of the Related Art

Japanese Patent Laid-open No. 2022-124716 discloses an image forming apparatus including a stacking surface on which a sheet discharged from the image forming apparatus is stacked, a stacking wall that regulates a trailing edge position of the sheet stacked on the stacking surface, and a blower fan that cools the sheet on the stacking surface via an air outlet formed in the stacking wall.

### SUMMARY

The present disclosure provides an image forming apparatus capable of sufficiently cooling a sheet.

An aspect of the present disclosure provides an image forming apparatus including a housing including a stacking portion on which a sheet discharged in a sheet discharge direction intersecting a vertical direction is stacked, and an upstream wall provided upstream of the stacking portion in the sheet discharge direction and facing an end portion of the sheet stacked on the stacking portion, a transfer portion at which a toner image is transferred to the sheet, a fixing device accommodated in the housing and configured to heat the toner image on the sheet to fix the toner image to the sheet, a discharge member configured to discharge the sheet to which the toner image is fixed by the fixing device from an inside to an outside of the housing in the sheet discharge direction, a reversing member configured to perform a reverse conveyance of the sheet having passed through the transfer portion and the fixing device, a first conveyance guide disposed so as to separate a first conveyance path through which the sheet is conveyed from the fixing device toward the discharge member and a second conveyance path through which the sheet having been subject to the reverse conveyance by the reversing member is conveyed toward the transfer portion, a fan configured to generate an air flow, a first air path forming portion including a first opening formed in the first conveyance guide, the first air path forming portion being configured to guide the air flow to the first conveyance path via the first opening, and a second air path forming portion including a second opening formed in the upstream wall, the second air path forming portion being configured to guide the air flow from the first conveyance path to the stacking portion via the second opening.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus according to a first embodiment.

FIG. 2 is a cross-sectional view illustrating a part of the image forming apparatus according to the first embodiment.

FIG. 3 is a view illustrating a state in which an opening/closing door of the image forming apparatus according to the first embodiment is opened.

FIG. 4 is a side view of the image forming apparatus according to the first embodiment.

FIG. 5 is a view illustrating the opening/closing door according to the first embodiment.

FIG. 6 is a view illustrating a first intermediate guide, a second intermediate guide, and a switching guide according to the first embodiment.

FIG. 7 is a view illustrating a discharge guide according to the first embodiment.

FIG. 8 is a perspective view illustrating an upper portion of the image forming apparatus according to the first embodiment.

FIG. 9 is a schematic view illustrating an arrangement of a blower fan according to a third embodiment.

FIG. 10 is a schematic view illustrating an arrangement of a blower fan according to a fourth embodiment.

FIG. 11 is a cross-sectional view illustrating a part of an image forming apparatus according to a fifth embodiment.

FIG. 12 is a cross-sectional view illustrating a part of an image forming apparatus according to a sixth embodiment.

### DESCRIPTION OF THE EMBODIMENTS

Hereinafter, embodiments according to the present disclosure will be described with reference to the drawings.

### First Embodiment

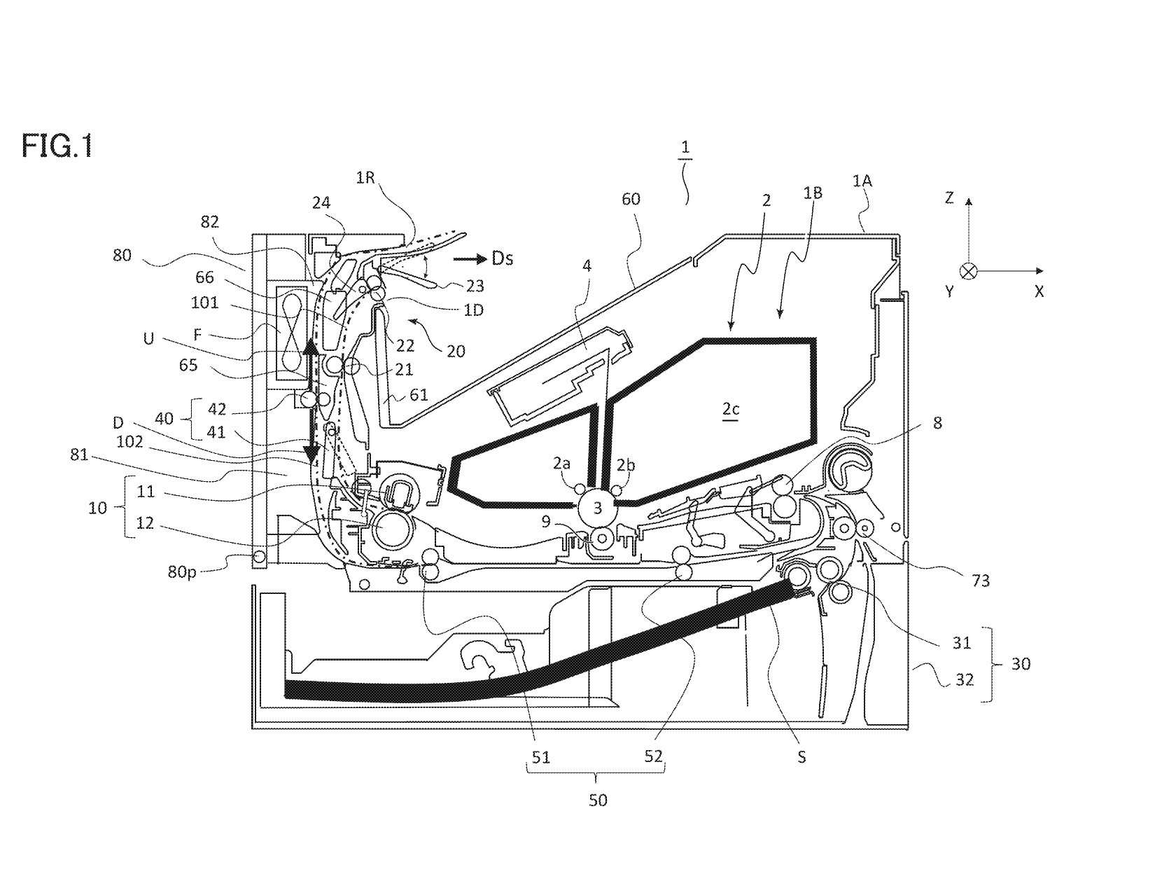

A first embodiment which is an embodiment of the present disclosure will be described with reference to FIGS. 1-8. As for an order of description, first, an overall configuration of an image forming apparatus 1 will be described, and next, a configuration related to sheet cooling will be described.

In the following description and drawings, a vertical direction (direction of gravity) when the image forming apparatus 1 is installed on a horizontal plane is defined as a Z-axis direction. A direction of a rotation axis of a photosensitive drum 3 (image bearing member) included in the image forming apparatus 1 is defined as a Y-axis direction. A direction intersecting both the Z-axis direction and the Y-axis direction is defined as an X-axis direction. The X-axis direction, the Y-axis direction, and the Z-axis direction may preferably be orthogonal to each other.

Positive and negative directions along each coordinate axis are denoted by a plus (+) or minus (-) sign, as necessary. For example, a positive direction along an X axis (a direction indicated by an arrow X in the drawing) is defined as a +X direction, and a negative direction along the X axis (a side opposite to the arrow X) is defined as a -X direction.

FIG. 1 is a cross-sectional view of the image forming apparatus 1 according to the first embodiment. The image forming apparatus 1 is a monochrome laser printer having a function of forming images on both sides of a sheet S (double-sided printing function). However, in the present disclosure, the “image forming apparatus” is not limited to a monochrome laser printer, and may be a color laser printer that forms a color image using toners of a plurality of colors. The “image forming apparatus” is not limited to a single-function printer having a printing function of forming an image on the sheet S based on image information received from the outside, and may be a copier capable of copying a document, a facsimile, or a multifunction peripheral having a plurality of functions of a printer, a copier, and a facsimile.

As illustrated in FIG. 1, the image forming apparatus 1 includes a main body frame 1A, an image forming unit 1B, a feeder 30, a fixing device 10 (fixing unit), a discharge unit 20, a reverser 40, and a double-sided printing conveyor 50. The image forming unit 1B includes a process cartridge 2, a scanner unit 4, and a transfer roller 9. The image forming apparatus 1 includes an opening/closing door 80 and a blower fan F. The opening/closing door 80 and the blower fan F are described below.

The process cartridge 2 is attachable to and detachable from a mounting space in the main body frame 1A. When a portion excluding the process cartridge 2 from the image forming apparatus 1 is an apparatus body of the image forming apparatus, it can be said that the process cartridge 2 is attachable to and detachable from the apparatus body.

The process cartridge 2 includes the photosensitive drum 3, a charging unit 2a, and a developing unit including a developing roller 2b and a developer container 2c. The photosensitive drum 3 functions as an image bearing member that bears a latent image and a developer image (toner image). The photosensitive drum 3 has a photosensitive layer formed of an organic photosensitive material on an outer peripheral portion of a cylindrical metal base. The charging unit 2a is, for example, a charging roller that comes into contact with the photosensitive drum 3. A toner serving as a developer is stored in the developer container 2c. The developing roller 2b is a developer carrier that carries the toner and supplies the toner to a facing portion where the developing roller 2b and the photosensitive drum 3 face each other.

The scanner unit 4 is disposed above the process cartridge 2. The scanner unit 4 includes a laser light source and an optical system that guides laser light emitted from the laser light source to the photosensitive drum 3. The transfer roller 9 is an example of a transfer member that transfers the toner image to the sheet S. A transfer nip serving as a transfer portion is formed as a nip portion between the transfer roller 9 and the photosensitive drum 3.

The “transfer portion” refers to a portion where the toner image is transferred from the image bearing member to the sheet S. In the present embodiment, the transfer portion is formed between the photosensitive drum 3 serving as the image bearing member and the transfer roller 9. However, in an intermediate transfer system, the transfer portion is formed between an intermediate transfer member serving as the image bearing member and a secondary transfer member facing the intermediate transfer member. An example of the intermediate transfer member is an intermediate transfer belt, and an example of the secondary transfer member is a secondary transfer roller that comes into contact with an outer surface of the intermediate transfer belt.

The feeder 30 includes a cassette 32 (a sheet storage unit and a feeding tray) on which the sheet S is supported and stored, and a feeding unit 31. As the sheet S serving as a recording material (recording medium), various sheet materials having different sizes and materials, for example, paper such as plain paper or thick paper, a sheet material subjected to surface treatment such as coated paper, a sheet material having a special shape such as an envelope or index paper, a plastic film, and cloth, can be used. The cassette 32 is mounted on the main body frame 1A in a drawable manner. The feeding unit 31 includes, for example, a pickup roller positioned above a lifting plate in the cassette 32 and a separation roller pair disposed downstream of the pickup roller in a sheet feeding direction. The separation roller pair includes a conveyance roller and a separation roller that is in pressure contact with the conveyance roller. The separation roller is an example of a separation member that separates the sheet S by applying a frictional force to the sheet S at a separation nip between the conveyance roller and the separation roller.

The main body frame 1A includes a frame member such as a sheet metal member that forms a frame of the image forming apparatus 1 and a cover member that forms an external appearance of the image forming apparatus 1. The main body frame 1A forms a substantially rectangular parallelepiped external appearance surface of the image forming apparatus 1 together with the opening/closing door 80 described below. The main body frame 1A and the opening/closing door 80 can be collectively referred to as a housing of the image forming apparatus 1.

The main body frame 1A accommodates a sheet discharge roller pair 22. The sheet discharge roller pair 22 includes a discharge roller. The Y-axis direction is parallel to a direction of a rotation axis of the discharge roller included in the sheet discharge roller pair 22. An upper surface of the main body frame 1A forms a sheet discharge tray 60. The sheet discharge tray 60 is a stacking portion on which the sheet S discharged in a sheet discharge direction Ds by the sheet discharge roller pair 22 is stacked. The sheet discharge direction Ds is a direction intersecting the vertical direction (Z-axis direction). The sheet discharge direction Ds in the present embodiment is a direction intersecting the Z-axis direction and orthogonal to the Y-axis direction, and is directed to the +X direction of the X-axis direction.

The main body frame 1A includes a discharge opening 1D and an upstream wall 61. The upstream wall 61 is provided upstream of the sheet discharge tray 60 in the sheet discharge direction Ds (first direction) and faces an end portion (a trailing edge in the sheet discharge direction Ds) of the sheet S stacked on the sheet discharge tray 60. The upstream wall 61 extends in a direction along the Z-axis direction below the discharge opening 1D in the Z-axis direction and above an upstream end of the sheet discharge tray 60 in the sheet discharge direction Ds. The discharge opening 1D is an opening through which the sheet S discharged from the inside to the outside of the housing by the sheet discharge roller pair 22 passes. The discharge opening 1D is formed above the upstream wall 61.

The fixing device 10 is accommodated in the main body frame 1A. That is, the fixing device 10 is accommodated in the housing of the image forming apparatus 1. The fixing device 10 heats the toner image on the sheet S to fix the toner image on the sheet S.

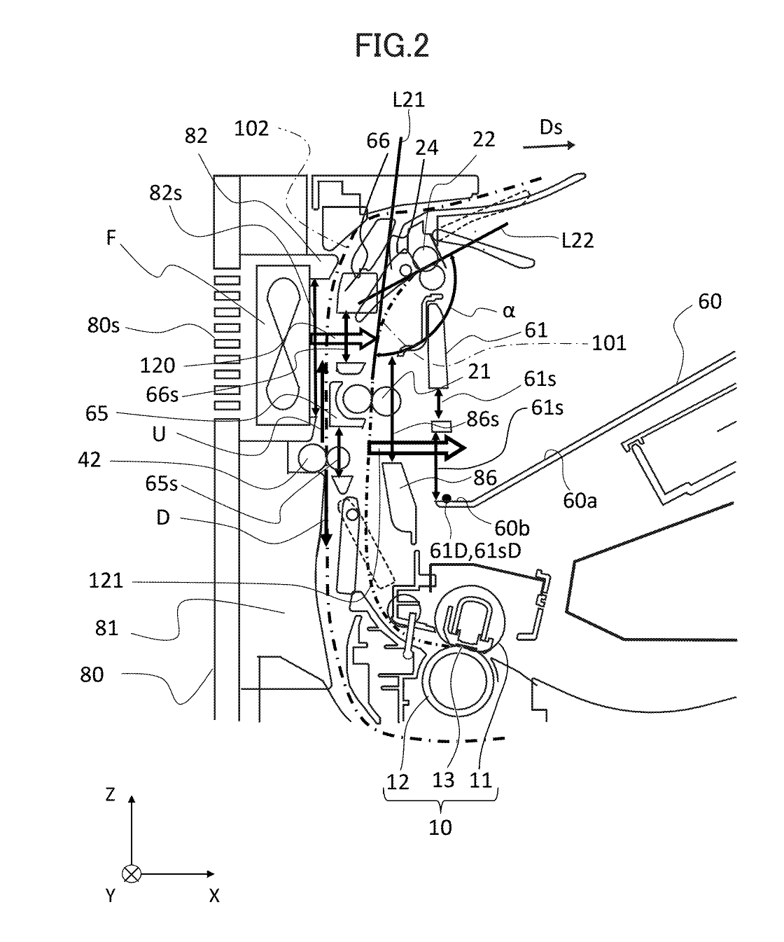

The fixing device 10 of the present embodiment is a film heating type device including a film 11 serving as a fixing member, a heater 13 (FIG. 2) that heats the film 11, and a pressure roller 12 that comes into contact with an outer surface of the film 11. The film 11 is a tubular member formed of a flexible resin sheet, metal sheet, or composite material sheet. The heater 13 is disposed in an internal space of the film 11. As the heater 13, for example, a ceramic heater in which a pattern of a heat-generating resistor that generates heat when energized is printed on a ceramic substrate can be used. The heater 13 is held by a heater holder, and the heater holder is held by a metal stay serving as a reinforcing member. When the metal stay is biased toward the pressure roller 12 by a spring member (not illustrated), the heater 13 and the heater holder come into pressure contact with the pressure roller 12 with the film 11 interposed therebetween. As a result, a fixing nip is formed between the film 11 and the pressure roller 12.

Here, the film heating type fixing device 10 has been exemplified, but the configuration of the fixing device 10 is not limited thereto. For example, as the fixing member, a rigid cylindrical roller member may be used, or a belt member stretched around a plurality of rollers may be used. As the heating unit, a halogen lamp that generates radiant heat when energized or a coil that causes the fixing member itself to generate heat by the principle of induction heating may be used.

The discharge unit 20 includes an intermediate conveyance roller pair 21, the sheet discharge roller pair 22, and a full-load detection sensor 23. The sheet discharge roller pair 22 is an example of a discharge member that discharges the sheet S on which the toner image has been fixed by the fixing device 10 from the inside to the outside of the housing of the image forming apparatus 1 in the sheet discharge direction Ds. The intermediate conveyance roller pair 21 is disposed between the fixing device 10 and the sheet discharge roller pair 22 in a sheet conveyance direction from the fixing device 10 toward the sheet discharge roller pair 22. The full-load detection sensor 23 includes a flag configured to pivot by being pressed against the sheet S discharged toward the sheet discharge tray 60 by the sheet discharge roller pair 22, and a detection unit (for example, a photointerrupter) that detects the pivoting of the flag.

The reverser 40 includes a reverse conveyance roller pair 42 and a switching guide 41. The reverse conveyance roller pair 42 is an example of a reversing member that performs a reverse conveyance of the sheet having passed through the transfer nip (transfer portion) and the fixing device 10. The reverse conveyance roller pair 42 performs the reverse conveyance of the sheet S having a first side on which the image is formed in the case of forming images on both sides of the sheet S. The reverse conveyance roller pair 42 is configured to be reversely rotatable in order to perform a reverse conveyance operation (switchback operation) of conveying the sheet S in a second conveyance direction D opposite to a first conveyance direction U after the sheet S is conveyed in the first conveyance direction U (an upward direction in the drawing). The main body frame 1A has a reverse opening 1R that allows a part of the sheet S to protrude to the outside of the image forming apparatus 1 during the reverse conveyance operation.

The switching guide 41 is a flap-shaped guide member that switches a conveyance path of the sheet S. The switching guide 41 can move between a discharge position (a first position or a first posture which corresponds to a solid line position in FIG. 1) for guiding the sheet S to a first conveyance path 101 described below and a reverse position (a second position and a second posture which corresponds to a broken line position in FIG. 2) for guiding the sheet S to a second conveyance path 102.

The double-sided printing conveyor 50 includes a double-sided printing conveyance roller pair 51 and a re-feeding roller pair 52. The double-sided printing conveyance roller pair 51 and the re-feeding roller pair 52 are configured to convey (re-feed) the sheet S reversed by the reverse conveyance roller pair 42 toward the image forming unit 1B again.

### Image Forming Operation

An image forming operation which is a series of operations in which the image forming apparatus 1 forms an image on the sheet S while conveying the sheet S will be described. A control unit of the image forming apparatus 1 performs the image forming operation, for example, in a case where the image information and an image formation instruction (printing signal) are received from the outside.

When the image forming operation is started, the photosensitive drum 3 is driven by a motor and starts to rotate, and the charging unit 2a uniformly charges a surface of the photosensitive drum 3. The control unit generates a video signal based on the received image information. The scanner unit 4 is driven according to the video signal, and irradiates the photosensitive drum 3 with light for exposure to write an electrostatic latent image corresponding to the image information on the surface of the photosensitive drum 3. The electrostatic latent image is developed into the toner image by the toner supplied to the photosensitive drum 3 by the developing roller 2b.

Further, the sheets S stored in the cassette 32 are fed one by one by the feeding unit 31 driven by a feeding motor. The fed sheet S is conveyed to a registration roller pair 8 via a conveyance roller pair 73, and is subjected to skew feeding correction by the registration roller pair 8. The registration roller pair 8 conveys the sheet S to the transfer nip according to a timing at which the toner image formed on the photosensitive drum 3 reaches the transfer nip.

A positive transfer voltage is applied to the transfer roller 9 at the transfer nip, so that the toner image is transferred from the photosensitive drum 3 to the sheet S. The sheet S having passed through the transfer nip is sent to the fixing device 10 and is subjected to image fixing processing. The fixing device 10 heats and pressurizes the toner image on the sheet S while nipping and conveying the sheet S at the fixing nip.

In the case of single-sided printing in which an image is formed on one side of the sheet S, the switching guide 41 waits for the sheet S at the discharge position (solid line position). The sheet S having passed through the fixing device 10 is guided to the first conveyance path 101 by the switching guide 41 at the discharge position. The sheet S guided to the first conveyance path 101 is conveyed toward the sheet discharge roller pair 22 via the intermediate conveyance roller pair 21. Then, the sheet S is discharged to the outside of the image forming apparatus 1 by the sheet discharge roller pair 22 and is stacked on the sheet discharge tray 60.

When the sheet S is discharged from the inside to the outside of the image forming apparatus 1, the sheet S comes into contact with the flag of the full-load detection sensor 23 and lifts the flag. When an amount of a sheet bundle stacked on the sheet discharge tray 60 increases, the flag of the full-load detection sensor 23 is continuously lifted by an upper surface of the sheet bundle. In a case where the full-load detection sensor 23 continuously detects the presence of the sheet S, the control unit of the image forming apparatus 1 determines that the sheet discharge tray 60 is full.

On the other hand, in the case of double-sided printing in which images are formed on both sides of the sheet S, the switching guide 41 waits at the reverse position (dotted line position). The sheet S having passed through the fixing device 10 is guided to the second conveyance path 102 by the switching guide 41 at the reverse position. The reverse conveyance roller pair 42 performs a reverse conveyance operation for the sheet S as follows. The reverse conveyance roller pair 42 conveys the sheet S in the first conveyance direction U (the upward direction in the drawing) toward the reverse opening 1R, and then reversely rotates after the trailing edge of the sheet S passes through the switching guide 41 and before the sheet S passes through the reverse conveyance roller pair 42 to convey the sheet S in the second conveyance direction D.

When the trailing edge of the sheet S passes through the switching guide 41, the switching guide 41 returns to the solid line position in FIG. 1. Therefore, the sheet S reversed by the reverse conveyance roller pair 42 is prevented from moving back to the first conveyance path 101.

Thereafter, the image is formed on the back side of the sheet S reversed by the reverse conveyance roller pair 42 in the same process as in the single-sided printing. That is, the sheet S conveyed from the re-feeding roller pair 52 is sequentially subjected to skew feeding correction of the registration roller pair 8, the transfer of the toner image at the transfer nip, and the image fixing processing by the fixing device 10. After the images are formed on both sides of the sheet S, the sheet S is guided to the first conveyance path by the switching guide 41. Then, the sheet S is discharged to the sheet discharge tray 60 in a state in which the images are formed on the first and second sides.

### Sheet Conveyance Path

Next, a configuration of a sheet conveyance path positioned downstream of the fixing device 10 will be described with reference to FIGS. 1 and 2. FIG. 2 is an enlarged view of a part of the image forming apparatus 1 of FIG. 1. FIGS. 1 and 2 are views of the image forming apparatus 1 when viewed in the Y-axis direction.

In the image forming apparatus 1, the sheet conveyance path (conveyance path) which is a conveyance space communicating from the cassette 32 to the sheet discharge tray 60 is formed. The sheet conveyance path of the present embodiment includes the first conveyance path 101 and the second conveyance path 102.

The first conveyance path 101 is a conveyance path (discharge path) along which the sheet S is conveyed from the fixing device 10 toward the sheet discharge roller pair 22. The second conveyance path 102 is a conveyance path (a reverse path and a double-sided printing path) along which the sheet S having been subject to the reverse conveyance by the reverse conveyance roller pair 42 is conveyed again toward the transfer nip (transfer portion). The second conveyance path 102 of the present embodiment includes a path from the reverse conveyance roller pair 42 to the registration roller pair 8 via the double-sided printing conveyance roller pair 51 and the re-feeding roller pair 52. The second conveyance path 102 includes a space from the reverse conveyance roller pair 42 to the reverse opening 1R. The second conveyance path 102 can also be referred to as a conveyance path that branches at a position downstream of the fixing nip from an image forming path from the cassette 32 to the sheet discharge tray 60 via the transfer nip and the fixing nip, and joins the image forming path at a position upstream of the registration roller pair 8.

The switching guide 41 is disposed in a communicating portion (connecting portion) where the first conveyance path 101 and the second conveyance path 102 communicate with each other. The discharge position (solid line position) of the switching guide 41 described above can be said to be a position where the switching guide 41 closes the communicating portion so as to restrict the movement of the sheet S from one of the first conveyance path 101 and the second conveyance path 102 to the other. The reverse position (dotted line position) of the switching guide 41 can be said to be a position where the switching guide 41 closes the first conveyance path 101 and opens the communicating portion.

The image forming apparatus 1 includes a discharge guide 86, a first intermediate guide 65, a second intermediate guide 66, a first reverse guide 81, and a second reverse guide 82.

Each of the first intermediate guide 65 and the second intermediate guide 66 is an example of a first conveyance guide forming the first conveyance path 101. Each of the first reverse guide 81 and the second reverse guide 82 is an example of a second conveyance guide disposed on a side opposite to the first conveyance guide with respect to the second conveyance path 102. The discharge guide 86 is an example of a third conveyance guide disposed on a side opposite to the first conveyance guide with respect to the first conveyance path 101.

The discharge guide 86 is disposed on one side of the first conveyance path 101, and the first intermediate guide 65 and the second intermediate guide 66 are disposed on the other side of the first conveyance path 101. That is, the discharge guide 86 is disposed so as to face the first side of the sheet S conveyed through the first conveyance path 101. The first intermediate guide 65 and the second intermediate guide 66 are disposed so as to face the second side opposite to the first side of the sheet S conveyed through the first conveyance path 101. Here, the first side and the second side are merely distinguished for the sake of convenience, and do not need to coincide with, for example, the order of image formation at the time of double-sided printing.

The first reverse guide 81 and the second reverse guide 82 are disposed on one side of the second conveyance path 102, and the first intermediate guide 65 and the second intermediate guide 66 are disposed on the other side of the second conveyance path 102. That is, the first reverse guide 81 and the second reverse guide 82 are disposed so as to face the first side of the sheet S conveyed through the second conveyance path 102. The first intermediate guide 65 and the second intermediate guide 66 are disposed so as to face the second side opposite to the first side of the sheet S conveyed through the second conveyance path 102. Here, the first side and the second side are merely distinguished for the sake of convenience.

The first intermediate guide 65 and the second intermediate guide 66 are disposed so as to separate the first conveyance path 101 and the second conveyance path 102 from each other. That is, the first intermediate guide 65 and the second intermediate guide 66 are disposed between two conveyance paths (101 and 102) extending in a direction along the Z-axis direction when viewed in the Y-axis direction and arranged in the X-axis direction.

The second intermediate guide 66 is disposed above the first intermediate guide 65. That is, the second intermediate guide 66 is disposed downstream of the first intermediate guide 65 in the sheet conveyance direction (and the first conveyance direction U of the reverse conveyance roller pair 42) from the fixing device 10 toward the sheet discharge roller pair 22 in the first conveyance path 101.

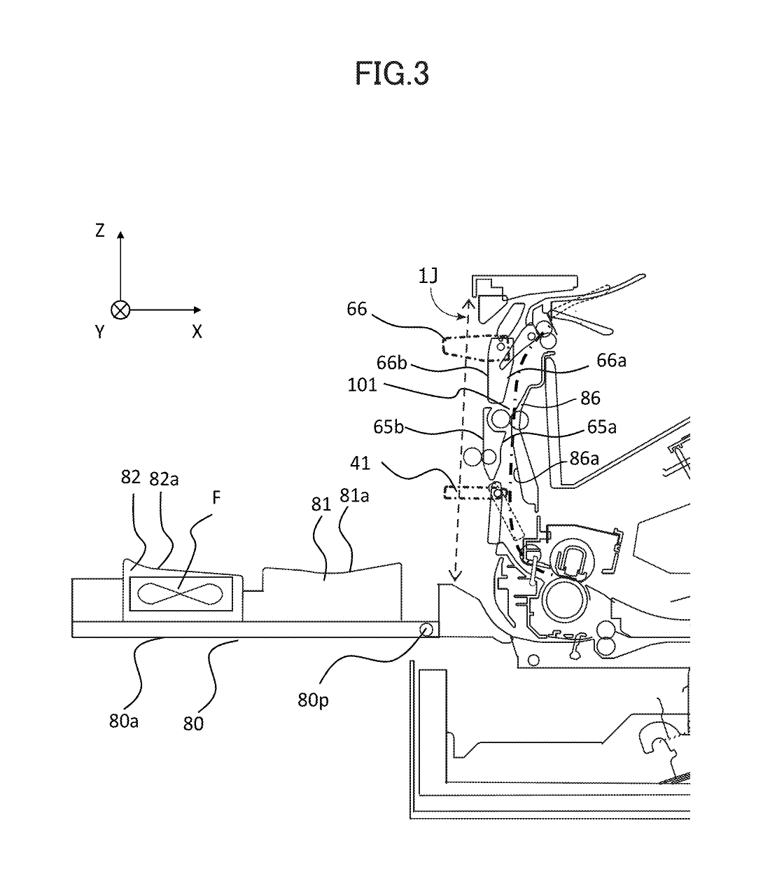

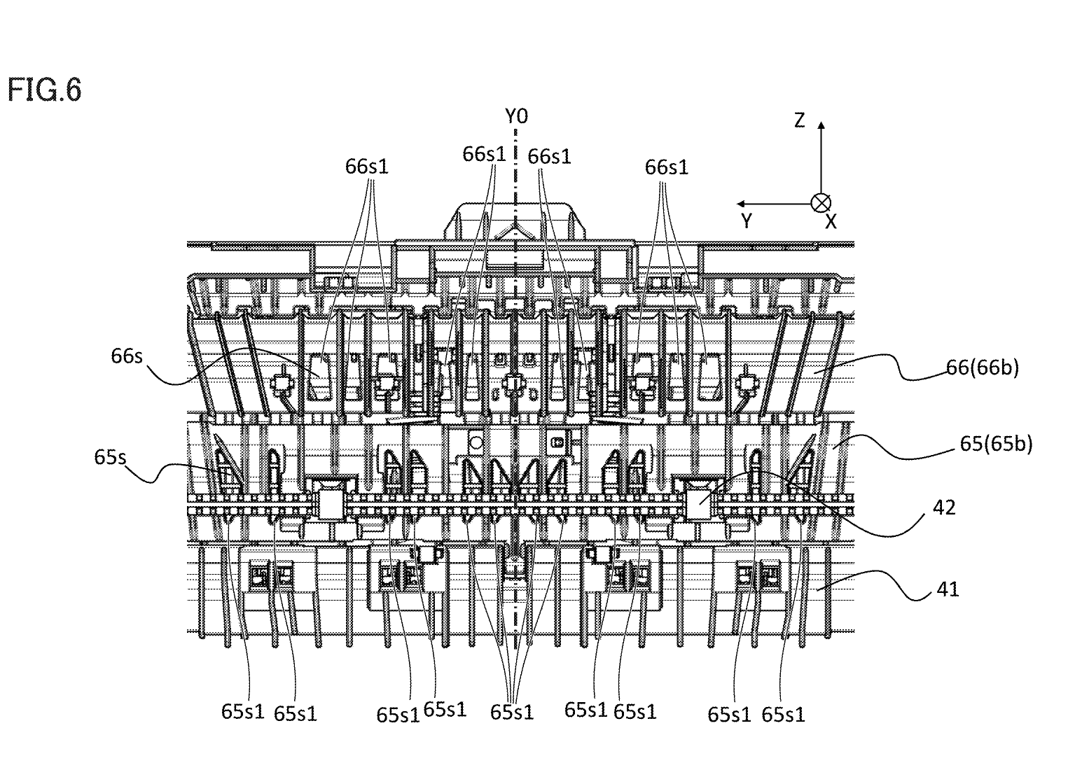

The first intermediate guide 65 includes a discharge-side guide portion 65a, and the second intermediate guide 66 includes a discharge-side guide portion 66a, the discharge-side guide portions 65a and 66a forming at least a part of a wall surface of the first conveyance path 101 (see also FIG. 3). The first intermediate guide 65 includes a reverse-side guide portion 65b, and the second intermediate guide 66 includes a reverse-side guide portion 66b, the reverse-side guide portions 65b and 66b forming at least a part of a wall surface of the second conveyance path 102 (see also FIGS. 3 and 6). When at least one of the first intermediate guide 65 and the second intermediate guide 66 is referred to as the first conveyance guide, the discharge-side guide portions 65a and 66a are first side portions of the first conveyance guide, and the reverse-side guide portions 65b and 66b are second side portions of the first conveyance guide.

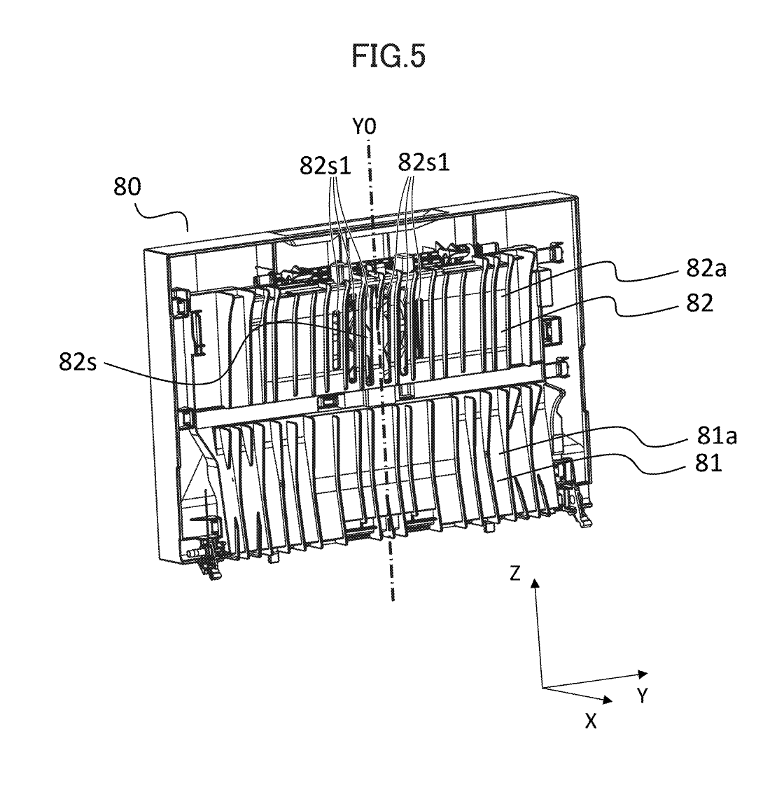

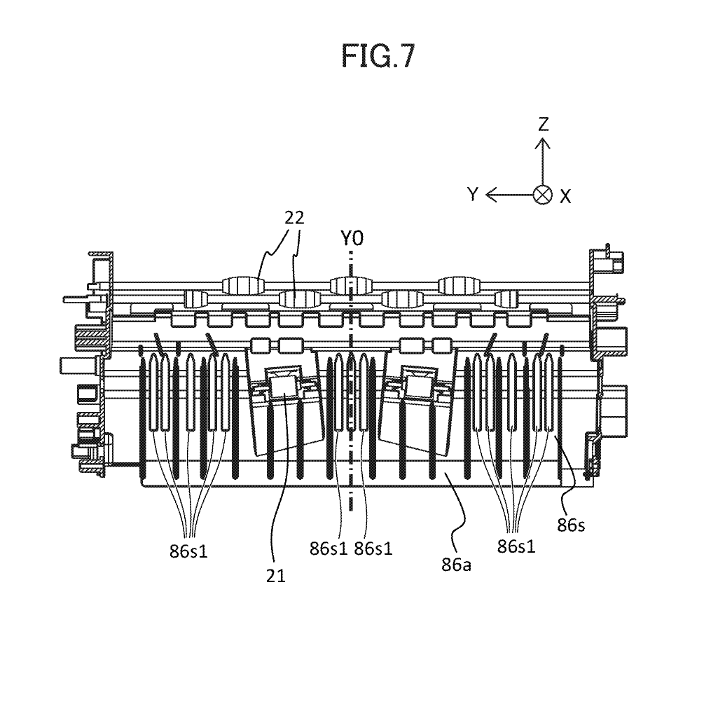

The discharge guide 86 includes a guide portion 86a that forms at least a part of the wall surface of the first conveyance path 101 (see also FIGS. 3 and 7). The first reverse guide 81 includes a guide portion 81a, and the second reverse guide 82 includes a guide portion 82a, the guide portions 81a and 82a forming at least a part of the wall surface of the second conveyance path 102 (see also FIGS. 3 and 5).

In the present embodiment, the discharge-side guide portions 65a and 66a of the first intermediate guide 65 and the second intermediate guide 66 face the guide portion 86a of the discharge guide 86. For example, when viewed in the X-axis direction, the discharge-side guide portion 65a of the first intermediate guide 65 overlaps the guide portion 86a of the discharge guide 86, and the discharge-side guide portion 66a of the second intermediate guide 66 overlaps the guide portion 86a of the discharge guide 86.

Here, the fact that two elements overlap each other when viewed in a specific direction means that a projected region of one element and a projected region of the other element at least partially overlap each other when the respective elements are vertically projected on a virtual plane perpendicular to the specific direction.

In the present embodiment, the reverse-side guide portions 65b and 66b of the first intermediate guide 65 and the second intermediate guide 66 face a guide portion 82a of the second reverse guide 82. Further, the reverse-side guide portion 65b of the first intermediate guide 65 faces the guide portion 81a of the first reverse guide 81. For example, when viewed in the X-axis direction, the reverse-side guide portion 65b of the first intermediate guide 65 overlaps with the guide portion 82a of the second reverse guide 82, and the reverse-side guide portion 66b of the second intermediate guide 66 overlaps with the guide portion 82a of the second reverse guide 82. Further, for example, when viewed in the X-axis direction, the reverse-side guide portion 65b of the first intermediate guide 65 overlaps with the guide portion 81a of the first reverse guide 81.

A rib for enhancing slidability with respect to the sheet S may be formed at each of the guide portions included in the discharge guide 86, the first intermediate guide 65, the second intermediate guide 66, the first reverse guide 81, and the second reverse guide 82 (FIGS. 5-7). The ribs are a plurality of protrusions arranged side by side in the X-axis direction which is a sheet width direction and each extending in the sheet conveyance direction. Each guide portion is provided with an opening portion that forms a flow path (air path) of cooling air described below.

### Opening/Closing Door

The opening/closing door 80 of the image forming apparatus 1 will be described with reference to FIGS. 1 and 3. FIG. 3 is a cross-sectional view illustrating the image forming apparatus 1 in a state in which the opening/closing door 80 is opened. FIG. 3 is a view of the image forming apparatus 1 when viewed in the Y-axis direction.

The opening/closing door 80 is an opening/closing unit (door unit) that is movable between a closed position (FIG. 1) where the opening/closing door 80 closes a back-side opening 1J, which is an opening portion formed in the main body frame 1A, and an open position (FIG. 3) where the opening/closing door 80 opens the back-side opening 1J. The back-side opening 1J is formed at an end portion of the main body frame 1A in a direction opposite to the sheet discharge direction Ds (first direction). The opening/closing door 80 is pivotably supported by the main body frame 1A about a pivot shaft 80p positioned at a lower end portion of the opening/closing door 80 when the opening/closing door 80 is at the closed position.

As illustrated in FIG. 3, the first reverse guide 81 and the second reverse guide 82 are included in the opening/closing door 80. The discharge guide 86, the first intermediate guide 65, the second intermediate guide 66, the switching guide 41, and the like are included in the main body frame 1A. When the opening/closing door 80 is moved from the closed position to the open position, the first reverse guide 81 and the second reverse guide 82 move away from the first intermediate guide 65, the second intermediate guide 66, and the switching guide 41. That is, as the opening/closing door 80 is opened, the back-side opening 1J is opened such that at least a part of the second conveyance path 102 is exposed to the outside of the image forming apparatus 1. Therefore, in a case where a jam (paper jam) in which the sheet S is caught in the second conveyance path 102 occurs, a user can open the opening/closing door 80, access the second conveyance path 102, and remove the caught sheet S.

In addition, there is provided an interlocking mechanism that moves the switching guide 41 from the discharge position or the reverse position to a position (retracted position) indicated by a line with alternating long and short dashes in the drawing in conjunction with an operation of moving the opening/closing door 80 from the closed position to the open position. When the switching guide 41 is at the retracted position, for example, the communicating portion between the first conveyance path 101 and the second conveyance path 102 is exposed when viewed in the X-axis direction from the outside of the image forming apparatus 1. Therefore, for example, when a jam (paper jam) in which the sheet S is caught between the fixing device 10 and the intermediate conveyance roller pair 21 occurs in the first conveyance path 101, the user can open the opening/closing door 80, access the first conveyance path 101, and remove the caught sheet S.

In addition, there is provided an interlocking mechanism that moves the second intermediate guide 66 from a position (solid line position) at the time of image formation to a position (retracted position) indicated by a line with alternating long and short dashes in the drawing in conjunction with the operation of moving the opening/closing door 80 from the closed position to the open position. When the second intermediate guide 66 is at the retracted position, for example, a part of the first conveyance path 101 is exposed above the intermediate conveyance roller pair 21 when viewed in the X-axis direction from the outside of the image forming apparatus 1. Therefore, for example, when a jam (paper jam) in which the sheet S is caught between the intermediate conveyance roller pair 21 and the sheet discharge roller pair 22 occurs in the first conveyance path 101, the user can open the opening/closing door 80, access the first conveyance path 101, and remove the caught sheet S.

The interlocking mechanism that moves the switching guide 41 or the second intermediate guide 66 to the retracted position in conjunction with the opening/closing door 80 may be omitted, and the user may manually move the switching guide 41 or the second intermediate guide 66 to the retracted position. For example, in a case where a conveyance distance from the fixing device 10 to the sheet discharge roller pair 22 is short, the switching guide 41 and the second intermediate guide 66 do not have to move to the retracted positions. In this case, the sheet S caught in the first conveyance path 101 is removed by, for example, the user pulling a leading edge of the sheet S protruding from the sheet discharge roller pair 22, or is removed by being pulled out to a position upstream of the fixing device 10 in a state in which the process cartridge 2 is removed.

### Cooling Configuration of Conveyance Path

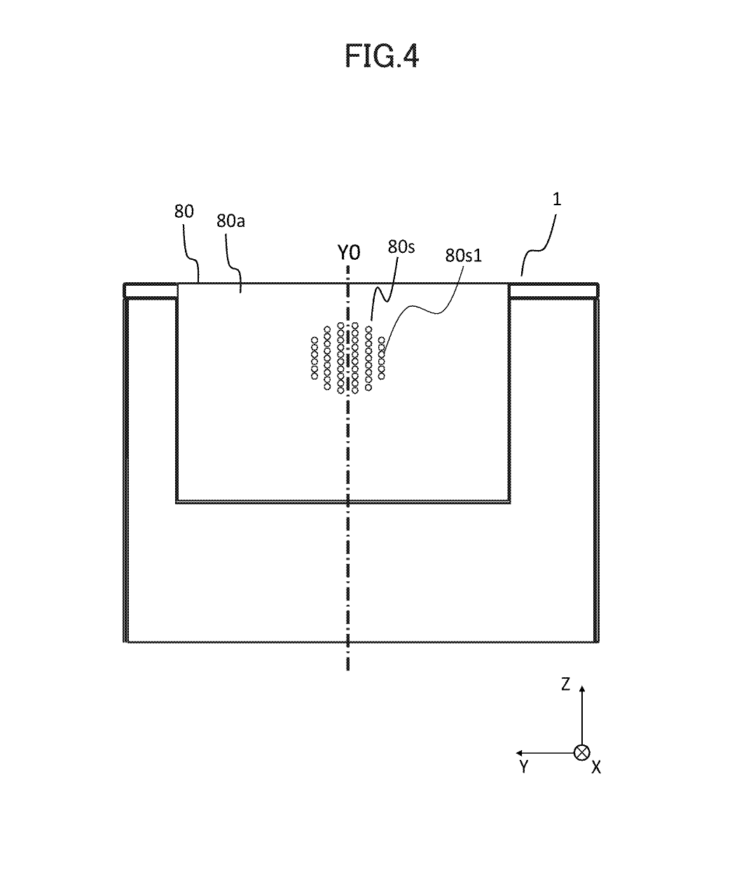

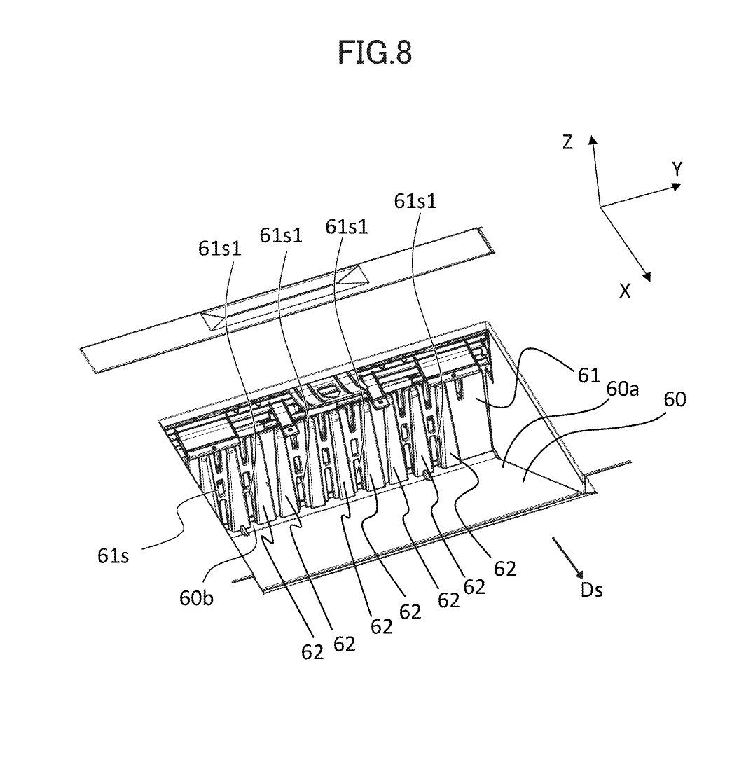

Next, a configuration for cooling the first conveyance path 101, the second conveyance path 102, and the sheet S passing through the first and second conveyance paths 101 and 102 will be described with reference to FIGS. 2 and 4-8. FIG. 2 is a cross-sectional view of the image forming apparatus 1 taken along a virtual plane extending in the Z-axis direction and the X-axis direction, and illustrates an opening or the like serving as the flow path of the cooling air. FIG. 4 is a side view of the image forming apparatus 1 when viewed in the Y-axis direction from the left side in FIG. 1. FIG. 5 is a perspective view of the opening/closing door 80. FIG. 6 is a view illustrating the image forming apparatus 1 in a state in which the opening/closing door 80 is opened when viewed in the X-axis direction. FIG. 7 is a view illustrating the discharge guide 86 and the sheet discharge roller pair 22 when viewed in the X-axis direction from the inside of the image forming apparatus 1. FIG. 8 is a perspective view illustrating an upper portion of the image forming apparatus 1.

As illustrated in FIGS. 2 and 3, the image forming apparatus 1 includes the blower fan F (fan) serving as a blower unit that generates an air flow. In the present embodiment, the blower fan F is attached to the inside of the opening/closing door 80.

As described below, the blower fan F takes in air from the outside of the image forming apparatus 1 via an intake port 80s to generate a flow of the air (cooling air). The flow of the air generated by the blower fan F sequentially passes through an inner air outlet 82s, the second conveyance path 102, first air vents 65s and 66s, the first conveyance path 101, a second air vent 86s, and an outer air outlet 61s, and is blown to the sheet S on the sheet discharge tray 60.

Each of the first air vents 65s and 66s is an example of a first opening formed in the first intermediate guide 65 or the second intermediate guide 66, which serves as the first conveyance guide. The outer air outlet 61s is an example of a second opening formed in the upstream wall 61. The inner air outlet 82s is an example of a third opening formed in the second reverse guide 82 serving as the second conveyance guide. The second air vent 86s is an example of a fourth opening formed in the discharge guide 86 serving as the third conveyance guide. In FIG. 2, arrows extending in an up-down direction and indicating the first air vents 65s and 66s, the outer air outlet 61s, the inner air outlet 82s, and the second air vent 86s respectively indicate opening ranges of the first air vents 65s and 66s, the outer air outlet 61s, the inner air outlet 82s, and the second air vent 86s in the up-down direction.

In the image forming apparatus 1, a portion that guides the air flow generated by the blower fan F from the blower fan F to the first conveyance path 101 can be referred to as a first air path forming portion 120, and a portion that guides the air flow from the first conveyance path 101 to the sheet discharge tray 60 can be referred to as a second air path forming portion 121.

The first air path forming portion 120 in the present embodiment includes the inner air outlet 82s, a part of the second conveyance path 102, and the first air vents 65s and 66s. The second air path forming portion 121 in the present embodiment includes the second air vent 86s and the outer air outlet 61s. That is, the first air path forming portion 120 of the present embodiment is configured to guide the air flow from the blower fan F to the first conveyance path 101 via the first air vents 65s and 66s serving as the first openings. The second air path forming portion 121 of the present embodiment is configured to guide the air flow from the first conveyance path 101 to the sheet discharge tray 60 via the outer air outlet 61s serving as the second opening.

As illustrated in FIGS. 2 and 4, the intake port 80s is formed in a cover member 80a forming an exterior surface of the opening/closing door 80. The intake port 80s is an opening through which the air taken into the image forming apparatus 1 from the outside passes during rotation of the blower fan F. The intake port 80s is positioned on an exterior surface side of the blower fan F.

The intake port 80s is formed on an end surface of the opening/closing door 80 that faces a direction (the -X direction of the X-axis direction) opposite to the sheet discharge direction Ds. The intake port 80s is formed in the cover member 80a at a position facing the blower fan F in the X-axis direction. That is, the blower fan F is disposed between the intake port 80s and the second conveyance path 102 in the sheet discharge direction Ds. The intake port 80s in the illustrated example is formed by a plurality of round holes 80s1 arranged regularly, but a shape, number, position, and the like of the openings (holes) forming the intake port 80s can be changed.

As illustrated in FIGS. 2 and 5, the inner air outlet 82s is formed in the second reverse guide 82. The inner air outlet 82s is an opening (third opening) through which the air is discharged from the blower fan F toward the second conveyance path 102. The inner air outlet 82s penetrates from the guide portion 82a of the second reverse guide 82 to a surface opposite to the guide portion 82a (a surface facing the blower fan F in the X-axis direction). The inner air outlet 82s is positioned on a side opposite to the intake port 80s with respect to the blower fan F. The inner air outlet 82s faces the blower fan F in the X-axis direction.

The inner air outlet 82s of the present embodiment includes a plurality of elongated holes 82s1 arranged in the Y-axis direction. Each elongated hole 82s1 is formed between adjacent ribs formed in the guide portion 82a of the second reverse guide 82, and is elongated in the Z-axis direction. A shape, number, position, and the like of the openings (holes) forming the inner air outlet 82s are not limited thereto, and can be changed.

As illustrated in FIGS. 2 and 6, the first air vents 65s and 66s are formed in the first intermediate guide 65 and the second intermediate guide 66. The first air vents 65s and 66s are openings (first openings) that form passages through which the air flows from the second conveyance path 102 to the first conveyance path 101. The first air vents 65s and 66s penetrate from the reverse-side guide portions 65b and 66b to the discharge-side guide portions 65a and 66a.

The first air vents 65s and 66s of the present embodiment include a plurality of elongated holes 65s1 and 66s1 arranged in the Y-axis direction. Each of the elongated holes 65s1 and 66s1 is formed at a position not overlapping the ribs formed in the reverse-side guide portions 65b and 66b and the discharge-side guide portions 65a and 66a when viewed in the X-axis direction, and is elongated in the Z-axis direction. A shape, number, position, and the like of the openings (holes) forming the first air vents 65s and 66s are not limited thereto, and can be changed. In the present embodiment, the first air vents 65s and 66s are formed in both the first intermediate guide 65 and the second intermediate guide 66, but the first air vent 65s or 66s may be formed only in one of the first intermediate guide 65 and the second intermediate guide 66.

As illustrated in FIGS. 2 and 7, the second air vent 86s is formed in the discharge guide 86. The second air vent 86s is an opening (fourth opening) that receives the air from the first conveyance path 101. The second air vent 86s penetrates from the guide portion 86a of the discharge guide 86 to a surface opposite to the guide portion 86a.

The second air vent 86s of the present embodiment includes a plurality of elongated holes 86s1 arranged in the Y-axis direction. Each elongated hole 86s1 is formed between adjacent ribs formed in the guide portion 86a of the discharge guide 86, and is elongated in the Z-axis direction. A shape, number, position, and the like of the openings (holes) forming the second air vent 86s are not limited thereto, and can be changed.

As illustrated in FIGS. 2 and 8, the outer air outlet 61s is formed in the upstream wall 61 of the main body frame 1A. The outer air outlet 61s is an opening (second opening) through which the air received by the second air vent 86s from the first conveyance path 101 is blown out into a space above the sheet discharge tray 60. The outer air outlet 61s penetrates from an outer surface to an inner surface of the upstream wall 61. The outer surface of the upstream wall 61 is a surface facing the outside of the image forming apparatus 1 (a surface on a right side of the upstream wall 61 in FIG. 2), and the inner surface of the upstream wall 61 is a surface facing the inside of the image forming apparatus 1 (a surface on a left side of the upstream wall 61 in FIG. 2).

The outer air outlet 61s of the present embodiment includes a plurality of elongated holes 61s1 arranged in the Y-axis direction. Each elongated hole 61s1 is formed between adjacent sheet edge receiving portions 62 (described below) and is elongated in the Z-axis direction. A shape, number, position, and the like of the openings (holes) forming the outer air outlet 61s are not limited thereto, and can be changed.

In the present embodiment, as illustrated in FIG. 2, the intake port 80s, the blower fan F, the inner air outlet 82s, the first air vents 65s and 66s, the second air vent 86s, and the outer air outlet 61s are arranged in this order in the +X direction which is a horizontal direction. In other words, the intake port 80s, the blower fan F, the inner air outlet 82s, the first air vents 65s and 66s, the second air vent 86s, and the outer air outlet 61s are arranged in this order in the +X direction when viewed in the Y-axis direction (a direction along the rotation axis of the discharge roller included in the sheet discharge roller pair 22). It can also be said that the intake port 80s, the blower fan F, the inner air outlet 82s, the first air vents 65s and 66s, the second air vent 86s, and the outer air outlet 61s are arranged in this order from upstream to downstream of the sheet discharge direction Ds in the horizontal direction. As a result, flowing directions of the air flow can be aligned, and the air flow can be more smoothly guided.

As illustrated in FIG. 2, it may be preferable that the opening range of the intake port 80s and the opening range of the inner air outlet 82s in the vertical direction (Z-axis direction) overlap each other. Overlapping between an opening range of a certain opening (first opening) and an opening range of another opening (second opening) in the vertical direction means that a range from an upper end position to a lower end position of the first opening and a range from an upper end position to a lower end position of the second opening at least partially overlap each other on the Z axis. In other words, overlapping between an opening range of one opening (first opening) and an opening range of another opening (second opening) in the vertical direction means that at least a part of the first opening and at least a part of the second opening are at the same position in the vertical direction.

It may be preferable that the opening range of the inner air outlet 82s (third opening) and the opening ranges of the first air vents 65s and 66s (first openings) in the vertical direction (Z-axis direction) overlap each other. It may be preferable that the opening ranges of the first air vents 65s and 66s (first openings) and the opening range of the second air vent 86s (fourth opening) in the vertical direction (Z-axis direction) overlap each other. It may be preferable that the opening range of the second air vent 86s (fourth opening) and the opening range of the outer air outlet 61s (second opening) in the vertical direction (Z-axis direction) overlap each other.

As described above, the openings are arranged such that the opening ranges of adjacent openings in the vertical direction overlap each other in a direction in which the air flows, so that the air flows more easily. The respective openings may be arranged such that the adjacent openings overlap each other in the direction in which the air flows when viewed in the X-axis direction.

As illustrated in FIGS. 4-7, each of the inner air outlet 82s, the first air vents 65s and 66s, the second air vent 86s, and the outer air outlet 61s may preferably be formed symmetrically with respect to a conveyance center Y0 which is the center of the conveyance path in the Y-axis direction (sheet width direction). The conveyance center Y0 is a reference of a position of the sheet S conveyed at the time of image formation in the Y-axis direction. In order to avoid occurrence of skew feeding of the sheet S, contact surfaces that come into contact with the sheet S in the conveyance roller pairs such as the sheet discharge roller pair 22 and the reverse conveyance roller pair 42 are arranged symmetrically with respect to the conveyance center Y0.

As the inner air outlet 82s, the first air vents 65s and 66s, the second air vent 86s, and the outer air outlet 61s are formed symmetrically with respect to the conveyance center Y0, the sheet S, the first conveyance path 101, and the second conveyance path 102 can be cooled in a balanced manner in the Y-axis direction.

Hereinafter, a flow of the air during the conveyance of the sheet S (during the image forming operation) and advantages of the present embodiment over a comparative example will be described.

Hereinafter, an operation of performing the single-sided printing on each sheet S while continuously conveying a plurality of sheets S is referred to as continuous single-sided printing. An operation of performing the double-sided printing on each sheet S while continuously conveying a plurality of sheets S is referred to as continuous double-sided printing. The continuous single-sided printing and the continuous double-sided printing may be simply referred to as “continuous printing”. In the continuous printing, an interval from passing of the trailing edge of a preceding sheet to passing of the leading edge of a following sheet among two sheets S conveyed continuously at a specific portion of the sheet conveyance path is referred to as a sheet interval or a paper gap.

### Cooling of Sheet During Continuous Printing

In the continuous printing, the air discharged from the first air vents 65s and 66s cools the sheet S passing through the first conveyance path 101. In a case where the sheet S is not passing through the first conveyance path 101, the air discharged from the first air vents 65s and 66s directly crosses the first conveyance path 101, enters the second air vent 86s, and is discharged from the outer air outlet 61s. The air discharged from the outer air outlet 61s mainly cools the uppermost sheet S of the sheet bundle stacked on the sheet discharge tray 60.

Even when the sheet S is passing through the first conveyance path 101, a part of the air discharged from the first air vents 65s and 66s bypasses the sheet S or passes through the sheet S to enter the second air vent 86s.

As a first comparative example for the present embodiment, a configuration in which the air from the blower fan F cools the sheet S on the sheet discharge tray 60 without passing through the first conveyance path 101 will be considered. However, in the configuration of the comparative example, there is a possibility that the cooling of the sheet S on the sheet discharge tray 60 becomes insufficient particularly when the sheet interval during the continuous printing is short. In a case where the cooling of the sheet S on the sheet discharge tray 60 is insufficient, heat is confined inside the stacked sheet bundle, and the toner on the sheet S that is softened at the time of fixing and then fixed is softened again, as a result of which sticking between the sheets S may occur.

Specifically, the shorter the sheet interval in the continuous printing, the shorter the time from when one sheet S is discharged onto the sheet discharge tray 60 until the next discharged sheet S overlaps the one sheet S. In other words, when focusing on an arbitrary sheet S other than the last sheet S in the continuous printing, a time for which the sheet S corresponds to the uppermost sheet on the sheet discharge tray 60 (that is, a time for which the air from the blower fan F is applied to the sheet S) is shortened. Therefore, in the first comparative example, the shorter the sheet interval in the continuous printing, the shorter the time for which the air from the blower fan F is applied to each sheet, and thus, the cooling of the sheet S tends to be insufficient.

According to the present embodiment, the air from the blower fan F is applied to the sheet S passing through the first conveyance path 101. Therefore, even in a case where the sheet interval in the continuous printing is shortened, the air from the blower fan F is applied to the sheet S at least during a period in which the sheet S passes through positions facing the first air vents 65s and 66s in the first conveyance path 101. In addition, as in the first comparative example, the sheet S is cooled by the air discharged from the outer air outlet 61s during a period in which the sheet S discharged to the sheet discharge tray 60 corresponds to the uppermost sheet.

As described above, according to the present embodiment, the sheet S can be cooled both when the sheet S passes through the first conveyance path 101 and when the sheet S corresponds to the uppermost sheet on the sheet discharge tray 60. Therefore, the sheet S can be sufficiently cooled. Further, by shortening the sheet interval in the continuous printing, it is possible to sufficiently cool the sheet S while enhancing productivity of the image forming apparatus 1.

As described above, according to the present embodiment, it is possible to provide an image forming apparatus capable of sufficiently cooling a sheet.

### Cooling of Sheet During Continuous Double-Sided Printing

Next, a flow of the air in the continuous double-sided printing will be described. In the continuous double-sided printing, the air discharged from the inner air outlet 82s cools the sheet S that is passing through the second conveyance path 102. In a case where the sheet S is not passing through the second conveyance path 102, the air discharged from the inner air outlet 82s directly crosses the second conveyance path 102, enters the first air vents 65s and 66s, and is discharged to the first conveyance path 101. The air discharged from the first air vents 65s and 66s to the first conveyance path 101 cools the sheet S that is passing through the first conveyance path 101. In a case where the sheet S is not passing through the first conveyance path 101, the air discharged from the first air vents 65s and 66s directly crosses the first conveyance path 101, enters the second air vent 86s, and is discharged from the outer air outlet 61s. The air discharged from the outer air outlet 61s mainly cools the uppermost sheet S of the sheet bundle stacked on the sheet discharge tray 60.

By cooling the sheet S that is passing through the second conveyance path 102, it is possible to suppress temperature rise of components disposed in the second conveyance path 102 and the periphery thereof, and it is possible to suppress deformation of a component having a low heat resistance.

According to the present embodiment, it is possible to further cool the sheet S conveyed through the second conveyance path 102 by using the blower fan F that generates the air for cooling the sheet S in the first conveyance path 101 and the sheet S in the sheet discharge tray 60. Therefore, the second conveyance path 102 can be cooled with a simple configuration.

In particular, in the present embodiment, the inner air outlet 82s is disposed downstream of the reverse conveyance roller pair 42 in the first conveyance direction U. Then, after the sheet S is cooled by the air discharged from the inner air outlet 82s in the middle of the reverse conveyance operation, the sheet S is conveyed from the reverse conveyance roller pair 42 toward the registration roller pair 8. Therefore, for example, as compared with a configuration in which the air for cooling the sheet S is applied between the reverse conveyance roller pair 42 and the registration roller pair 8 in the second conveyance path 102, the sheet S can be cooled at an earlier timing, and a range affected by heat can be reduced.

### Sliding with Friction against Conveyance Guide

A nip line L22 of the sheet discharge roller pair 22 obliquely intersects with a nip line L21 of the intermediate conveyance roller pair 21 when viewed in the Y-axis direction as illustrated in FIG. 2. An angle between the nip lines L21 and L22 is α. α may be, for example, 90° or more and 150° or less, and further may be 135° or less. That is, a movement direction of the sheet S at the nip portion of the sheet discharge roller pair 22 (a direction along the nip line L22) is different from a movement direction of the sheet S at the nip portion of the intermediate conveyance roller pair 21 (a direction along the nip line L21).

The second intermediate guide 66 serving as the first conveyance guide is positioned on an outer side of a curve of the sheet S in a state in which the sheet S is curved between the intermediate conveyance roller pair 21 and the sheet discharge roller pair 22.

Since a movement direction of the sheet S is different between the sheet discharge roller pair 22 and the intermediate conveyance roller pair 21 adjacent to the sheet discharge roller pair 22 and positioned upstream of the sheet discharge roller pair 22, the trailing edge of the sheet S may slide with friction against a conveyance guide 24 after the trailing edge of the sheet S passes through the intermediate conveyance roller pair 21. That is, when the trailing edge of the sheet S passes through the intermediate conveyance roller pair 21, a posture of the sheet S tends to straighten along the nip line L22 of the sheet discharge roller pair 22 due to a stiffness of the sheet S itself. At this time, there is a possibility that the trailing edge of the sheet S moves so as to approach the second intermediate guide 66 and slides with friction against the discharge-side guide portion 66a of the second intermediate guide 66. In the case of the double-sided printing, a sheet surface (hereinafter, referred to as a first printing surface) to which the image has been transferred at the first transfer slides with friction against the discharge-side guide portion 66a, as a result of which the toner is stripped off, and the discharge-side guide portion 66a may be contaminated with the toner, or disturbance of the image on the sheet S may occur.

According to the present embodiment, at least a part of the first air vents 65s and 66s (first openings) is positioned upstream of the intermediate conveyance roller pair 21 in the first conveyance path 101. Therefore, in the double-sided printing, the first printing surface of the sheet S can be cooled before the trailing edge of the sheet S passes through the intermediate conveyance roller pair 21, and it is possible to suppress the contamination of the discharge-side guide portion 66a with the toner and the disturbance of the image on the first printing surface of the sheet S.

### Position of Outer Air Outlet

In the present embodiment, a lower end 61sD (FIG. 2) of the outer air outlet 61s may be at the same height as a lower end 61D of the upstream wall 61 (see also FIG. 8). In other words, the lower end position of the second opening may be at the same height as an upper surface of the sheet discharge tray 60 at the upstream end of the sheet discharge tray 60 (stacking portion) in the sheet discharge direction Ds (first direction). For example, a groove with a lower end portion opened may be formed in the upstream wall 61, and the outer air outlet 61s may be formed by inserting an upward surface 60b continuous with a stacking surface 60a of the sheet discharge tray 60 into the groove (see also FIG. 8). Since the lower end 61sD of the outer air outlet 61s is at the same height as the lower end 61D of the upstream wall 61, the sheet S on the sheet discharge tray 60 can be efficiently cooled even in a case where the number of sheets S stacked on the sheet discharge tray 60 is small (for example, one sheet S is stacked).

### Arrangement of Blower Fan

In the present embodiment, the blower fan F is disposed above the reverse conveyance roller pair 42 so as to overlap the reverse conveyance roller pair 42 when viewed in the Z-axis direction (FIG. 2). In other words, the reverse conveyance roller pair 42 and the blower fan F are at different positions in the Z-axis direction, and an occupied range of the reverse conveyance roller pair 42 and an occupied range of the blower fan F in the X-axis direction at least partially overlap each other.

As a result, for example, as compared with an arrangement in which the blower fan F and the reverse conveyance roller pair 42 are arranged side by side in the X-axis direction, a thickness of the opening/closing door 80 in the X-axis direction can be reduced, so that the apparatus can be downsized.

### Outer Air Outlet and Sheet Edge Receiving Portion of Upstream Wall

As illustrated in FIG. 8, the upstream wall 61 includes a plurality of sheet edge receiving portions 62 that receive the trailing edge (an upstream end in the sheet discharge direction Ds) of the sheet S stacked on the sheet discharge tray 60. The plurality of sheet edge receiving portions 62 are arranged in the Y-axis direction. Each of the sheet edge receiving portions 62 protrudes in the sheet discharge direction Ds and extends in the Z-axis direction.

The outer air outlet 61s is disposed between the sheet edge receiving portions 62 adjacent to each other in the Y-axis direction. A portion of the upstream wall 61 at which the outer air outlet 61s is formed is retracted to a position upstream of the sheet edge receiving portion 62 in the sheet discharge direction Ds. In other words, the outer air outlet 61s is formed in a recess of the upstream wall 61, which is recessed with respect to the sheet edge receiving portion 62 that receives the trailing edge of the sheet S on the sheet discharge tray 60.

With such a configuration, even in a state in which the trailing edge of the sheet bundle on the sheet discharge tray 60 is in contact with the sheet edge receiving portion 62, the air discharged from the outer air outlet 61s can flow upward through the recess and reach the upper surface of the sheet bundle. That is, even when an amount of the stacked sheets on the sheet discharge tray 60 increases, it is possible to prevent cooling performance from deteriorating due to blocking of the flow path of the air from the outer air outlet 61s.

Hereinafter, embodiments whose configurations are partially different from the first embodiment will be described. Hereinafter, elements denoted by reference numerals common to the first embodiment will have basically the same configurations and actions as those described in the first embodiment unless otherwise specified, and portions different from those of the first embodiment will be mainly described.

### Second Embodiment

As a second embodiment, an intermediate conveyance roller pair 21 may be omitted from an image forming apparatus 1 in the first embodiment. In addition, a portion of a discharge guide 86 at which a second air vent 86s is formed in the first embodiment may be omitted. That is, air discharged from first air vents 65s and 66s (first opening) to a first conveyance path 101 may be directly discharged from an outer air outlet 61s (second opening) without passing through a second air vent 86s (fourth opening).

In a case where an influence on conveyance of a sheet S due to the omission of a part of the discharge guide 86 is small, a configuration of the present embodiment makes a flow of the air from the first conveyance path 101 to a sheet discharge tray 60 smoother, so that the sheet S on the sheet discharge tray 60 is more easily cooled.

### Third Embodiment

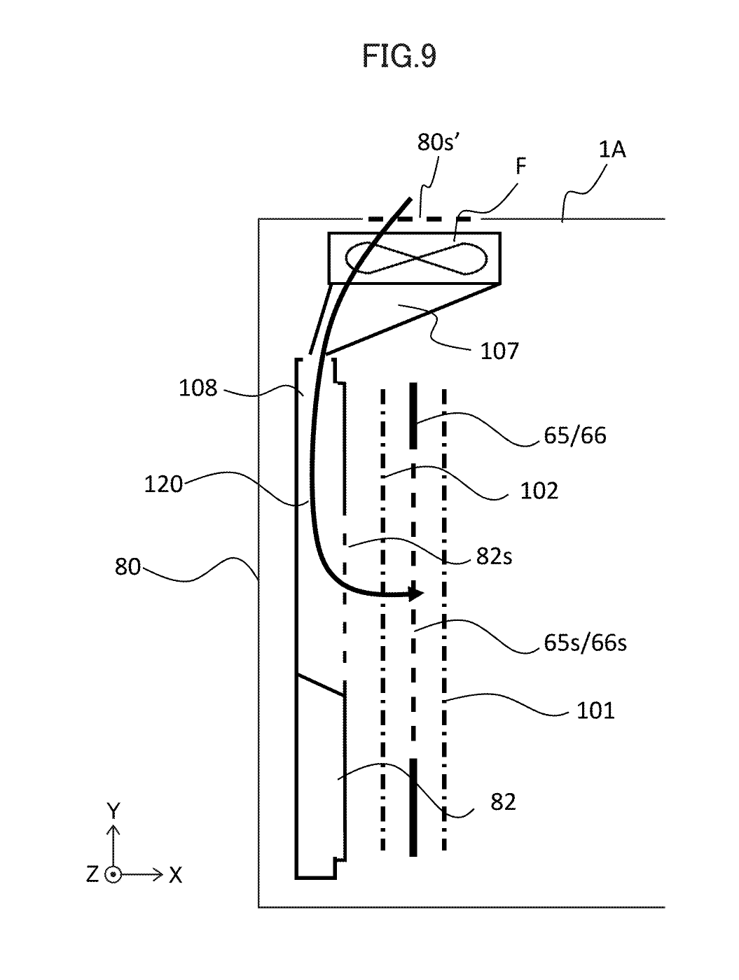

As a third embodiment, a blower fan F may be disposed at a portion other than an opening/closing door 80 as illustrated in FIG. 9. In the illustrated example, the blower fan F is disposed at an end portion of a main body frame 1A in the Y-axis direction.

An intake port 80s' is formed on an end surface of the main body frame 1A in the Y-axis direction. The blower fan F communicates with an inner air outlet 82s through ducts (107 and 108) extending in the Y-axis direction. The first duct 107 is provided in the main body frame 1A and connected to a discharge side of the blower fan F. The second duct 108 is provided in the opening/closing door 80. One end of the second duct 108 is connected to the first duct 107, and the inner air outlet 82s is formed at the other end of the second duct 108. That is, in the present embodiment, a first air path forming portion 120 that guides an air flow from the blower fan F to a first conveyance path 101 includes the duct (second duct 108) provided in the opening/closing door 80. A flow path of the air discharged from the inner air outlet 82s is the same as that in the first embodiment.

According to the present embodiment, the blower fan F is disposed at a portion other than the opening/closing door 80, so that a thickness of the opening/closing door 80 in the X-axis direction can be reduced.

### Fourth Embodiment

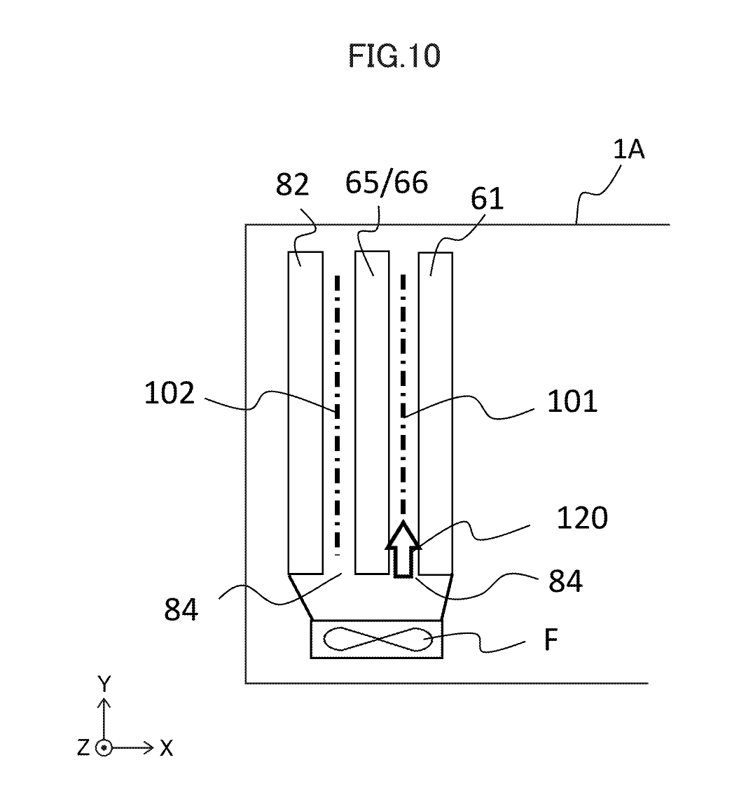

As a fourth embodiment, air may be sent from one end side in a sheet width direction (Y-axis direction) to a first conveyance path 101 and a second conveyance path 102 as illustrated in FIG. 10.

As illustrated in FIG. 10, an inner air outlet 84 is formed at each of an end portion of the first conveyance path 101 in the Y-axis direction and an end portion of the second conveyance path 102 in the Y-axis direction. Air discharged from a blower fan F enters each of the first conveyance path 101 and the second conveyance path 102 through the inner air outlets 84, and cools a sheet S that is passing through the first conveyance path 101 and a sheet S that is passing through the second conveyance path 102.

In the present embodiment, the blower fan F is disposed at the end portions of the first conveyance path 101 and the second conveyance path 102 in the Y-axis direction (second direction) which is a horizontal direction orthogonal to a sheet discharge direction Ds (first direction). A first air path forming portion 120 that guides an air flow from the blower fan F to the first conveyance path 101 includes the inner air outlet 84 serving as a first opening. The inner air outlets 84 are opened in both the first conveyance path 101 and the second conveyance path 102 at the end portions of the first conveyance path 101 and the second conveyance path 102 in the Y-axis direction.

The air entering the second conveyance path 102 enters the first conveyance path 101 through first air vents 65s and 66s described in the first embodiment. A flow path of the air after entering the first conveyance path 101 is the same as that in the first embodiment.

According to the present embodiment, the air can be sent to the first conveyance path 101 without being blocked by the sheet S that is passing through the second conveyance path 102. Therefore, for example, even when two sheets S pass through the first conveyance path 101 and the second conveyance path 102 at the same time, the sheet S in the first conveyance path 101 can be efficiently cooled.

According to the present embodiment, a thickness of an opening/closing door 80 in the X-axis direction can be reduced by disposing the blower fan F at a portion other than the opening/closing door 80 as in the third embodiment.

### Fifth Embodiment

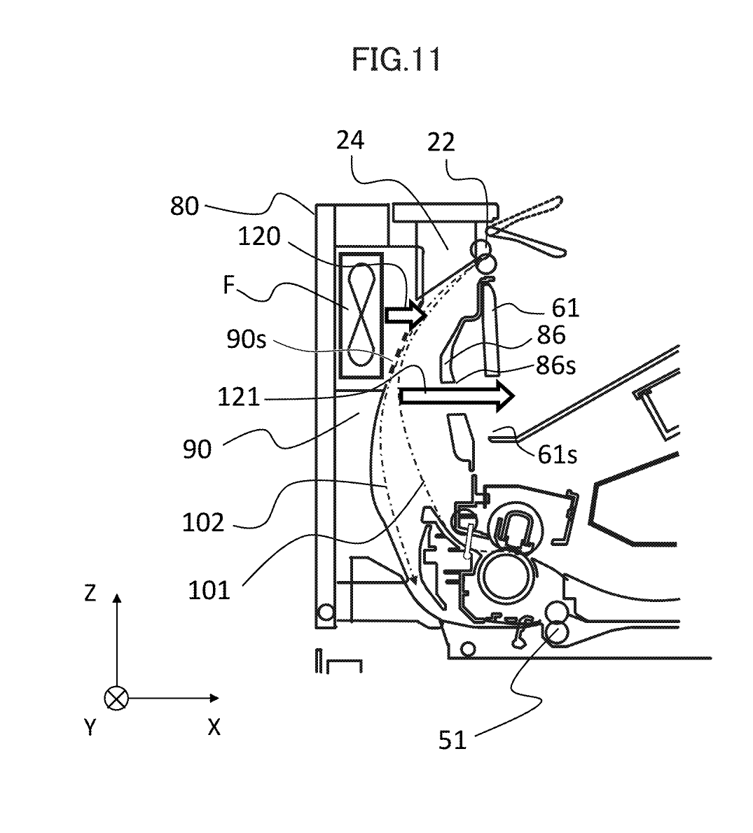

As a fifth embodiment, a conveyance path on which a sheet S is reversely conveyed and a conveyance path on which the sheet S is discharged do not have to be separated as illustrated in FIG. 11. In the present embodiment, a first intermediate guide 65 and a second intermediate guide 66 that separate a first conveyance path 101 from a second conveyance path 102 in the first embodiment are omitted. In the present embodiment, a reverse conveyance roller pair 42 and a switching guide 41 in the first embodiment are also omitted.

A sheet discharge roller pair 22 in the present embodiment functions as a reverse unit that performs a reverse conveyance of the sheet S. In the case of the double-sided printing, the sheet discharge roller pair 22 conveys the sheet S having a first side on which an image is formed in a sheet discharge direction Ds, reversely rotates before a trailing edge of the sheet S in the sheet discharge direction Ds passes through a nip portion of the sheet discharge roller pair 22, and conveys the sheet S in a direction opposite to the sheet discharge direction Ds.

An opening/closing door 80 is provided with a curved reverse guide 90. A leading edge of the sheet S conveyed in a direction opposite to the sheet discharge direction Ds by the sheet discharge roller pair 22 is guided toward a double-sided printing conveyance roller pair 51 along the curve of the reverse guide 90. An inner air outlet 90s is formed in the reverse guide 90.

Air from the blower fan F passes through the inner air outlet 90s, is discharged to a conveyance space that also serves as a first conveyance path 101 and a second conveyance path 102, and then passes through a second air vent 86s and is discharged from an outer air outlet 61s to a sheet discharge tray 60.

According to the present embodiment, the number of components can be reduced as compared with the first embodiment while providing a double-sided printing function, so that a product cost can be reduced.

### Sixth Embodiment

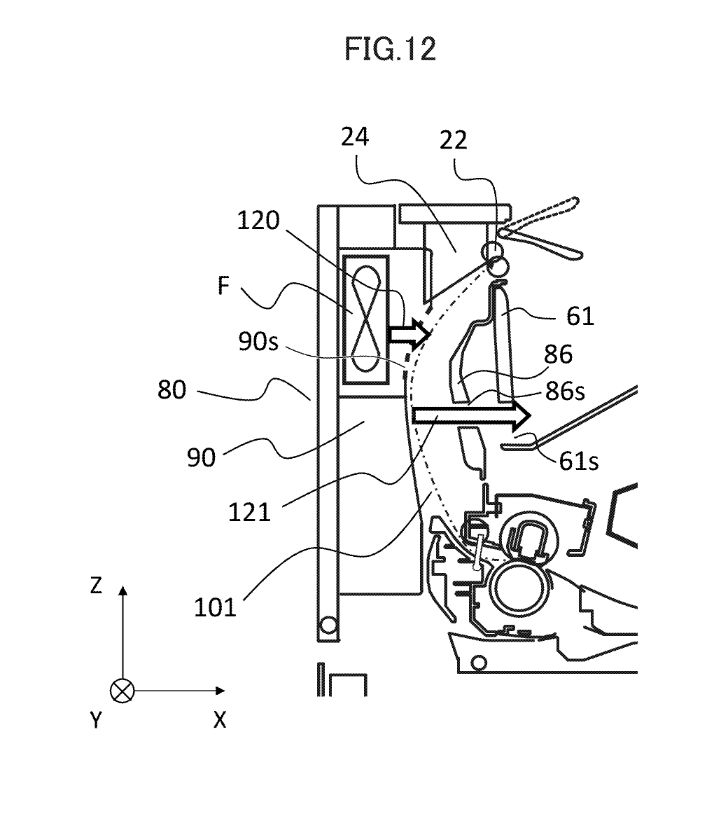

As a sixth embodiment, the present technology may be applied to an image forming apparatus 1 dedicated to single-sided printing, which does not have a double-sided printing function as illustrated in FIG. 12. In the present embodiment, air from a blower fan F is discharged from an inner air outlet 82s to a first conveyance path 101, and then passes through a second air vent 86s and is discharged from an outer air outlet 61s to a sheet discharge tray 60.

According to the present embodiment, the number of components can be further reduced as compared with the fifth embodiment, so that a product cost can be reduced.

### Other Modified Embodiments

In each of the above-described embodiments, the control unit of the image forming apparatus 1 may change the sheet interval during the continuous printing, an air volume of the blower fan F, a sheet conveyance speed, and the like according to attribute information (sheet information) of the sheet S.

For example, the image forming apparatus 1 includes a sheet information acquisition unit that acquires the sheet information such as smoothness, glossiness, and grammage of the sheet S. The sheet information acquisition unit may be an operation panel that receives the sheet information from the user, or a media sensor disposed on the sheet conveyance path. When the sheet S has high smoothness or glossiness, toner separation caused by sliding with friction against the conveyance guide tends to be conspicuous, and the sheets S tend to adhere closely to each other when the sheets S are stacked on the sheet discharge tray 60, as a result of which sticking between the sheets S is more likely to occur. Therefore, when the smoothness or glossiness of the sheet S is higher than a predetermined value, the sheet interval is widened, the air volume of the blower fan F is increased, or the conveyance speed of the sheet S is reduced as compared with a case where the smoothness or glossiness is lower than the predetermined value. As a result, it becomes possible to suppress toner separation and sticking between the sheets.

In each of the embodiments described above, the control unit of the image forming apparatus 1 may change the sheet interval during continuous printing, the air volume of the blower fan F, the sheet conveyance speed, and the like according to image information (print data) indicating an image to be formed on the sheet S.

For example, when an amount of the toner transferred to the sheet S at the time of image formation is large, toner separation caused by sliding with friction against the conveyance guide tends to be conspicuous, and image surfaces tend to adhere closely to each other when the sheets S are stacked on the sheet discharge tray 60, as a result of which sticking between the sheets S is more likely to occur. Therefore, in a case where it is determined from the image information that the amount of the toner transferred to the sheet S is larger than a predetermined amount, the sheet interval is widened, the air volume of the blower fan F is increased, or the conveyance speed of the sheet S is reduced as compared with a case where it is determined that the amount of the toner is smaller than the predetermined amount. As a result, it becomes possible to suppress toner separation and sticking between the sheets.

In the first to fifth embodiments described above, the control unit of the image forming apparatus 1 may change the sheet interval during the continuous printing, the air volume of the blower fan F, the sheet conveyance speed, and the like according to whether the printing is the single-sided printing or the double-sided printing.

In the double-sided printing, the toner images are transferred to both sides of the sheet S, and thus, the images are formed on the sheet surfaces of two sheets overlapping on the sheet discharge tray 60, the sheet surfaces facing each other. Therefore, sticking between the sheets is more likely to occur. Therefore, in the case of the double-sided printing, the sheet interval is widened, the air volume of the blower fan F is increased, or the conveyance speed of the sheet S is reduced as compared with the case of the single-sided printing. Accordingly, sticking between the sheets can be suppressed.

Hitherto, there has been a case where simply blowing air toward a sheet outside the image forming apparatus is insufficient to cool the sheet.

According to the present disclosure, it is possible to provide an image forming apparatus capable of sufficiently cooling a sheet.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-042693, filed Mar. 17, 2025, which is hereby incorporated by reference herein in its entirety.

What is claimed is:

1. An image forming apparatus comprising:
a housing including a stacking portion on which a sheet discharged in a sheet discharge direction intersecting a vertical direction is stacked, and an upstream wall provided upstream of the stacking portion in the sheet discharge direction and facing an end portion of the sheet stacked on the stacking portion;
a transfer portion at which a toner image is transferred to the sheet;
a fixing device accommodated in the housing and configured to heat the toner image on the sheet to fix the toner image to the sheet;
a discharge member configured to discharge the sheet to which the toner image is fixed by the fixing device from an inside to an outside of the housing in the sheet discharge direction;
a reversing member configured to perform a reverse conveyance of the sheet having passed through the transfer portion and the fixing device;
a first conveyance guide disposed so as to separate a first conveyance path through which the sheet is conveyed from the fixing device toward the discharge member and a second conveyance path through which the sheet having been subject to the reverse conveyance by the reversing member is conveyed toward the transfer portion;
a fan configured to generate an air flow;
a first air path forming portion including a first opening formed in the first conveyance guide, the first air path forming portion being configured to guide the air flow to the first conveyance path via the first opening; and
a second air path forming portion including a second opening formed in the upstream wall, the second air path forming portion being configured to guide the air flow from the first conveyance path to the stacking portion via the second opening.

2. The image forming apparatus according to claim 1, wherein
the first conveyance guide includes a first side portion forming a wall surface of the first conveyance path and a second side portion forming a wall surface of the second conveyance path, and
the first opening penetrates from the first side portion to the second side portion such that the air flow is guided from the second conveyance path to the first conveyance path via the first opening.

3. The image forming apparatus according to claim 2, further comprising:
a second conveyance guide disposed on a side opposite the first conveyance guide with respect to the second conveyance path
wherein the first air path forming portion includes a third opening formed in the second conveyance guide, and the air flow is guided from the fan to the second conveyance path via the third opening.

4. The image forming apparatus according to claim 3, further comprising:
a third conveyance guide disposed on a side opposite the first conveyance guide with respect to the first conveyance path,
wherein the second air path forming portion includes a fourth opening formed in the third conveyance guide such that the air flow is guided from the first conveyance path to the second opening via the fourth opening.

5. The image forming apparatus according to claim 4, wherein
the third opening, the first opening, the fourth opening, and the second opening are arranged in a horizontal direction in an order from upstream to downstream in the sheet discharge direction.

6. The image forming apparatus according to claim 5, wherein
an opening range of the third opening in the vertical direction and an opening range of the first opening in the vertical direction overlap each other,
the opening range of the first opening in the vertical direction and an opening range of the fourth opening in the vertical direction overlap each other, and
the opening range of the fourth opening in the vertical direction and an opening range of the second opening in the vertical direction overlap each other.

7. The image forming apparatus according to claim 1, wherein
the housing includes:
a main body frame including the stacking portion and the upstream wall and having an opening portion formed at an end portion in a direction opposite to the sheet discharge direction, and
an opening/closing unit configured to move between an open position where the opening/closing unit opens the opening portion to expose at least a part of the second conveyance path to an outside of the image forming apparatus and a closed position where the opening/closing unit closes the opening portion, and
the fan is provided in the opening/closing unit.

8. The image forming apparatus according to claim 7, wherein
the opening/closing unit includes a cover member forming an exterior surface of the image forming apparatus, and an intake port formed in the cover member and through which air is taken into the image forming apparatus from an outside during rotation of the fan.

9. The image forming apparatus according to claim 8, wherein
the intake port is formed on an end surface of the opening/closing unit that faces the direction opposite to the sheet discharge direction, and
the fan is disposed between the intake port and the second conveyance path in the sheet discharge direction and above the reversing member, and is disposed so as to overlap the reversing member when viewed in the vertical direction.

10. The image forming apparatus according to claim 1, wherein
the housing includes:
a main body frame including the stacking portion and the upstream wall and having an opening portion formed at an end portion on a side opposite to the sheet discharge direction, and
an opening/closing unit configured to move between an open position where the opening/closing unit opens the opening portion to expose at least a part of the second conveyance path to an outside of the image forming apparatus and a closed position where the opening/closing unit closes the opening portion,
the fan is provided in the main body frame, and
the first air path forming portion includes a duct provided in the opening/closing unit and configured to guide the air flow from the fan to the second conveyance path.

11. The image forming apparatus according to claim 10, wherein
the fan is disposed at the end portion of the main body frame in a horizontal direction orthogonal to the sheet discharge direction.

12. The image forming apparatus according to claim 1, wherein
the fan is disposed at end portions of the first conveyance path and the second conveyance path in a horizontal direction orthogonal to the sheet discharge direction, and
the first opening is opened in each of the first conveyance path and the second conveyance path at the end portions of the first conveyance path and the second conveyance path in the horizontal direction orthogonal to the sheet discharge direction.

13. The image forming apparatus according to claim 1, further comprising:
a roller pair disposed between the fixing device and the discharge member and configured to convey the sheet having passed through the fixing device toward the discharge member,
wherein a movement direction of the sheet at the roller pair is different from a movement direction of the sheet at the discharge member,
the first conveyance guide is positioned on an outer side of a curve of the sheet in a state in which the sheet is curved between the roller pair and the discharge member, and
at least a part of the first opening is positioned upstream of the roller pair in a sheet conveyance direction from the fixing device toward the discharge member.

14. The image forming apparatus according to claim 1, wherein
a lower end position of the second opening in the vertical direction is at a same height as an upper surface of the stacking portion at an upstream end of the stacking portion in the sheet discharge direction.
